(19) United States
(12) Patent Application Publication
(10) Pub. No.: US 2015/0261738 A1
(43) Pub. Date: Sep. 17, 2015

(54) INSPECTION SUPPORTING APPARATUS AND INSPECTION SUPPORTING METHOD

(71) Applicant: FUJITSU FSAS INC., Kawasaki-shi (JP)

(72) Inventors: Hirofumi IZUMI, Kawasaki (JP); Hiroshi NOGAWA, Kawasaki (JP); Motoki DAI, Kawasaki (JP); Shinichi KAWAHARA, Kawasaki (JP); Syuichiro SUETSUGU, Kawasaki (JP); Shinichi EGASHIRA, Kawasaki (JP); Yoji MORITA, Kawasaki (JP)

(73) Assignee: FUJITSU FSAS INC., Kawasaki-shi (JP)

(21) Appl. No.: 14/643,368

(22) Filed: Mar. 10, 2015

(30) Foreign Application Priority Data
Mar. 13, 2014 (JP) 2014-050554

(51) Int. Cl. G06F 17/24; G06F 3/0484

(52) U.S. Cl. CPC G06F 17/248; G06F 3/0484; G06F 3/04842

(57) ABSTRACT

An inspection supporting apparatus includes a storage unit and a generating unit, for example. The storage unit stores therein different types of templates for each check item that is an inspection object for which it is determined whether a predetermined criterion for a site to handle agricultural crops or foods is satisfied, and stores a master in which the types of the templates and an order of arrangement of the templates are defined for each inspection object. The generating unit, upon receiving a selection of the inspection object, generates a frame in which the templates are arranged based on the selected inspection object and the master.

### CROSS-REFERENCE TO RELATED APPLICATION(S)

This application is based upon and claims the benefit of priority of the prior Japanese Patent Application No. 2014-050554, filed on Mar. 13, 2014, the entire contents of which are incorporated herein by reference.

### FIELD

The embodiment discussed herein is related to an inspection supporting apparatus and the like.

### BACKGROUND

In recent years, farms, food processing companies, food delivery companies, and the like are requested to address food-safety issues and environmental conservation. For example, a third-party organization performs inspections on whether the farms, the processing companies, and the delivery companies conform to predetermined safety standards.

Consumers are highly concerned with the food safety, so that if foods are proven to be related to a farm, a food processing company, or a delivery company that has passed the inspection of the third-party organization, the consumers can purchase the foods with a sense of security. These related-art example are described, for example, in Japanese Laid-open Patent Publication No. 2011-86208.

However, in the above described conventional technique, it is difficult to efficiently support different types of inspections.

### SUMMARY

According to an aspect of an embodiment, an inspection supporting apparatus includes a memory that stores therein different types of templates for each check item that is an inspection object for which it is determined whether a predetermined criterion for a site to handle agricultural crops or foods is satisfied, and stores a master in which the types of the templates and an order of arrangement of the templates are defined for each inspection object; and a processor executes a process including: referring to the memory; and generating a frame in which the templates are arranged based on the selected inspection object and the master, upon receiving a selection of an inspection object.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system according to an embodiment;

FIG. 2 is a functional block diagram illustrating a configuration of an inspection supporting apparatus according to the embodiment;

FIG. 3 is a diagram illustrating an example of a data structure of a template table;

FIG. 4 is a diagram illustrating examples of templates;

FIG. 5A is a diagram illustrating an example of a data structure of master data;

FIG. 5B is a diagram illustrating an example of a data structure of frame information;

FIG. 6 is a diagram illustrating an example of a data structure of an inspection result table;

FIG. 7 is a diagram illustrating an example of a frame screen; and

FIG. 8 is a flowchart illustrating the flow of a process performed by the inspection supporting apparatus according to the embodiment.

### DESCRIPTION OF EMBODIMENTS

Preferred Embodiments of the Present Invention will be explained with reference to accompanying drawings. The present invention is not limited to the embodiments below.

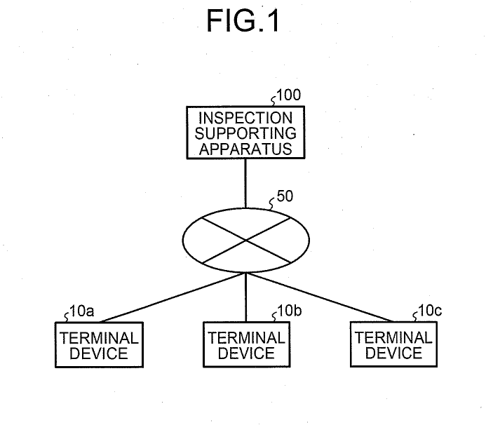

FIG. 1 is a diagram illustrating an example of a system according to an embodiment. As illustrated in FIG. 1, the system includes terminal devices 10a, 10b, and 10c and an inspection supporting apparatus 100. For example, the inspection supporting apparatus 100 and the terminal devices 10a, 10b, and 10c are connected to one another via a network 50. Herein, only the terminal devices 10a, 10b, and 10c are illustrated; however, other terminal devices may be connected to the network 50. In the description below, the terminal devices 10a, 10b, and 10c may be collectively referred to as the terminal device 10 as appropriate.

The terminal device 10 is a terminal device used by an inspector to inspect whether business entities that handle various foods conform to a predetermined standard. The terminal device 10 displays a frame screen containing a check item of an inspection object, and the inspector provides input on whether the check item is satisfied to the terminal device 10.

The inspector, when starting an inspection, operates the terminal device 10 and transmits a request for the frame screen to the inspection supporting apparatus 100. For example, the request for the frame screen contains business entity identification information for identifying a business entity to be an inspection object, and information on a target item. The target item indicates an item to be inspected among items handled by the business entity.

The terminal device 10, after transmitting the request for the frame screen, receives information on the frame screen from the inspection supporting apparatus 100 and displays the frame screen.

The inspection supporting apparatus 100, upon receiving the request for the frame screen, generates the frame screen for inspecting the business entity and the target item, and transmits information on the generated frame screen to the terminal device 10.

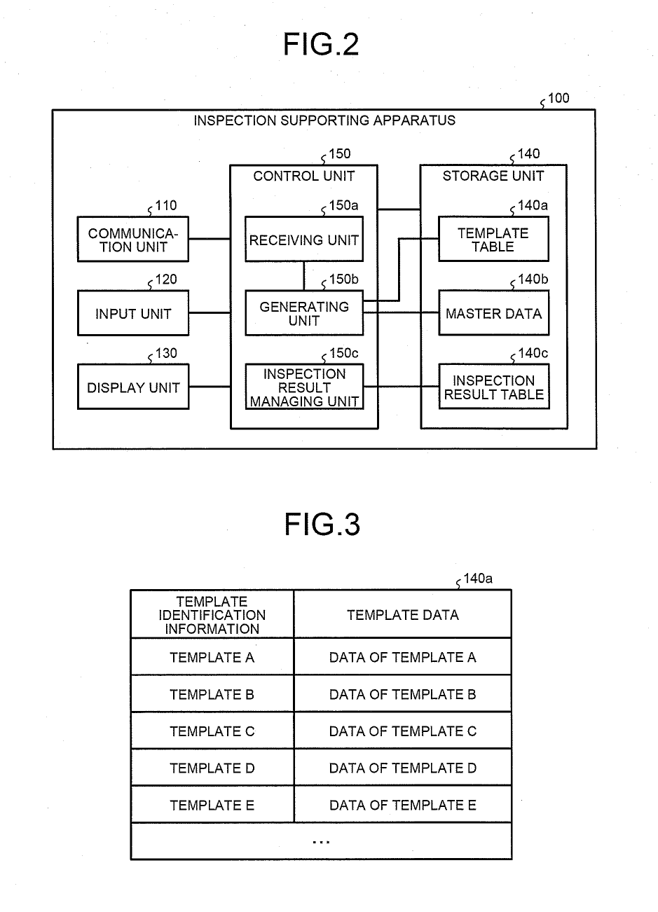

FIG. 2 is a functional block diagram illustrating a configuration of the inspection supporting apparatus according to the embodiment. As illustrated in FIG. 2, the inspection supporting apparatus 100 includes a communication unit 110, an input unit 120, a display unit 130, a storage unit 140, and a control unit 150.

The communication unit 110 is a processing unit that performs data communication with the terminal device 10 and other devices via the network 50. The communication unit 110 corresponds to a communication apparatus. The control unit 150 (to be described later) exchanges data with the terminal device 10 and other devices via the communication unit 110.

The input unit 120 is an input device that allows an administrator or the like to input data to the inspection supporting apparatus 100. For example, the input unit 120 corresponds to a keyboard, input keys, a touch panel, or the like. The display unit 130 is a display device that displays data or the like output from the control unit 150. The display unit 130 corresponds to, for example, a display or a touch panel.

The storage unit 140 stores therein a template table 140a, master data 140b, and an inspection result table 140c. The storage unit 140 corresponds to, for example, a semiconductor memory element, such as a random access memory (RAM), a read only memory (ROM), or a flash memory, or corresponds to a storage device, such as a hard disk drive (HDD).

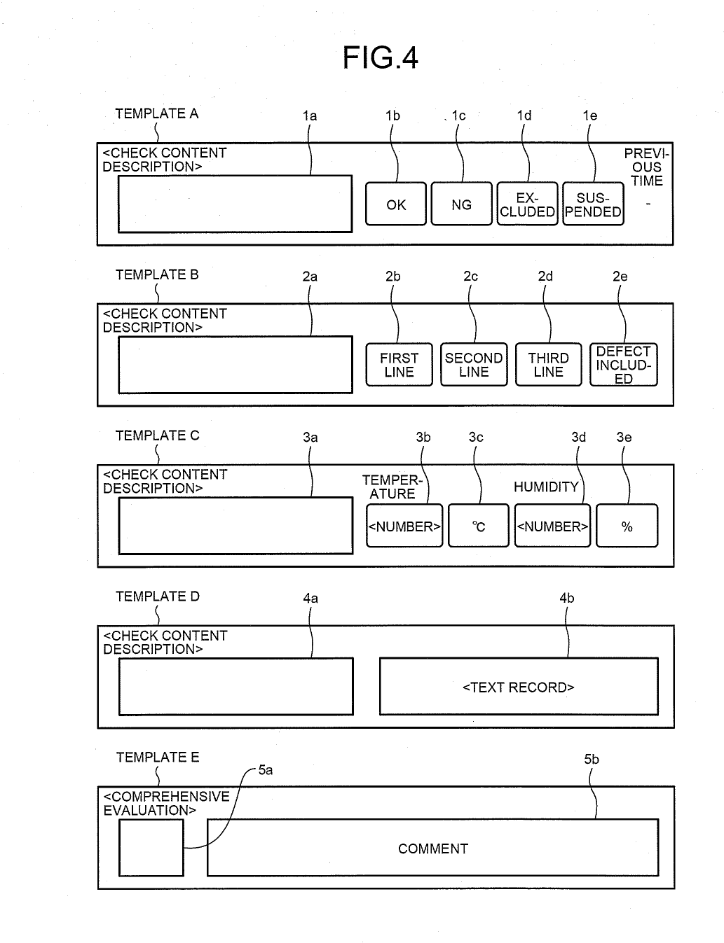

The template table 140a stores therein information on different types of templates for each check item to be an inspection object. FIG. 3 is a diagram illustrating an example of a data structure of the template table. As illustrated in FIG. 3, the template table 140a associates template identification information with template data. The template identification information is information for identifying a template. The template data is information on the template corresponding to the template identification information.

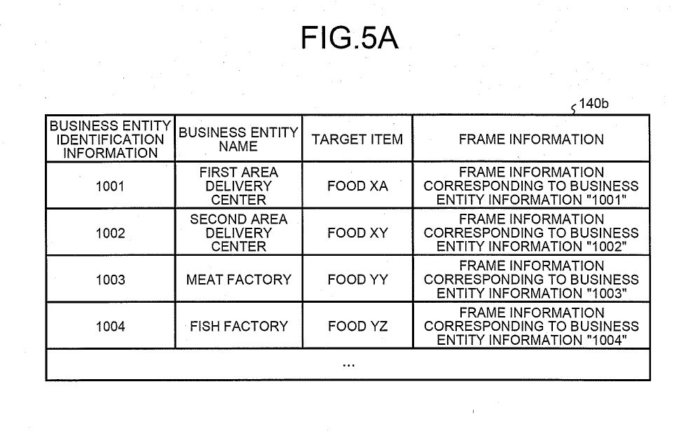

FIG. 4 is a diagram illustrating examples of the templates. Herein, templates A, B, C, D, and E will be described by way of example; however, the templates are not limited thereto.

The template A will be described. The template A corresponds to data of the template A in the template table 140a. The template A is used when a single recording is performed for a single check content.

As illustrated in FIG. 4, the template A includes a check content description 1a and buttons 1b, 1c, 1d, and 1e. In the check content description 1a, for example, text indicating a check content is stored. The button 1b is pressed by an inspector when the check content is satisfied. The button 1c is pressed by an inspector when the check content is not satisfied. The button 1d is pressed by an inspector when the check content is excluded from an inspection. The button 1e is pressed by an inspector when a check is suspended. When each of the buttons 1b, 1c, 1d, and 1e is pressed by the inspector, a pressed time is recorded.

The template B will be described. The template B corresponds to data of the template B in the template table 140a. The template B is used when a plurality of check contents are checked simultaneously in a single day.

As illustrated in FIG. 4, the template B includes a check content description 2a and buttons 2b, 2c, 2d, and 2e. In the check content description 2a, text indicating a check content is stored. The button 2b is pressed when an inspector checks a first line, and a pressed time is recorded. The button 2c is pressed when an inspector checks a second line, and a pressed time is recorded. The button 2d is pressed when an inspector checks a third line, and a pressed time is recorded. The button 2e is pressed by an inspector when any of the first to the third lines does not conform to the check content. The fact which of the lines has a defect is stored in a different template. For example, the fact may be recorded in the template E or the like as will be described later.

The template C will be described. The template C corresponds to data of the template C in the template table 140a. The template C is used when a value and a preset unit are recorded for a check content.

As illustrated in FIG. 4, the template C includes a check content description 3a, input fields 3b and 3d, and unit display areas 3c and 3e. In the check content description 3a, text indicating a check content is stored. The input field 3b is, for example, an area in which a value of temperature is input by an inspector. The input field 3d is, for example, an area in which a value of humidity is input by an inspector. The unit display area 3c is an area for indicating a unit of the value input in the input field 3b, and indicates “° C.”, for example. The unit display area 3e is an area for indicating a unit of the value input in the input field 3d, and indicates “%”, for example. The items in the input fields 3b and 3d can be replaced with other items, and the units in the unit display areas 3c and 3e can be replaced with other units.

For example, in the template C illustrated in FIG. 4, temperature and humidity are input; however, it may be possible to appropriately select an input field and a unit display area for “moisture” or the like, rather than the “temperature” and the “humidity” in the template C. For example, the input field 3b may be an area in which a value of “moisture” is input by an inspector, and the unit display area 3c may indicate “%”.

The template D will be described. The template D corresponds to data of the template D in the template table 140a. The template D is used when a comment on a check content is recorded.

As illustrated in FIG. 4, the template D includes a check content description 4a and a text record 4b. In the check content description 4a, text indicating a check content is stored. The text record 4b is an area in which a comment on the check content is input by an inspector.

The template E will be described. The template E corresponds to data of the template E in the template table 140a. The template E is used when a check content is evaluated on multiple levels.

As illustrated in FIG. 4, the template E includes a comprehensive evaluation 5a and a comment area 5b. In the comprehensive evaluation 5a, a number or a symbol indicating an evaluation is input. As the number indicating the evaluation, for example, “5, 4, 3, 2, 1, or 0” is input. As the symbol indicating the evaluation, for example, “A, B, C, D, E, or F” is input. The comment area 5b is an area in which a comment on the comprehensive evaluation by the inspector is input, for example. In the template E, it may be possible to input, in the comment area 5b, the fact which of the first to the third lines specified by the template B has a defect.

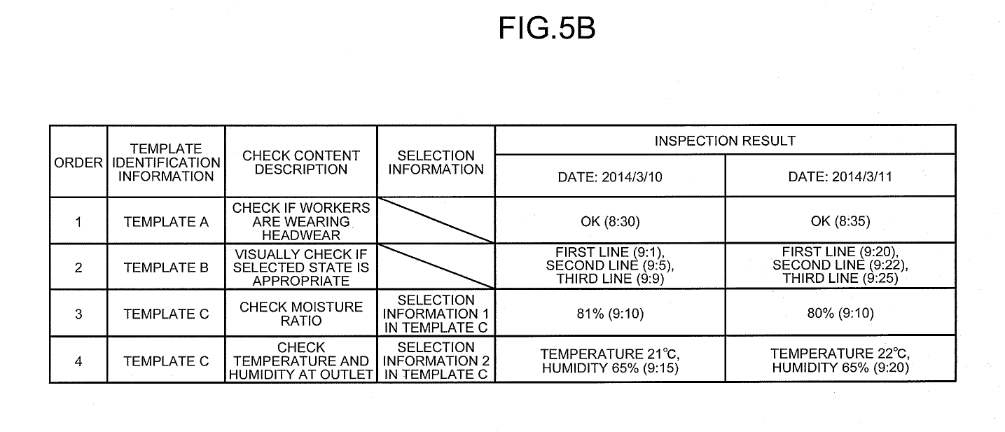

Referring back to FIG. 2, the master data 140b is data that defines types of templates and the order of arrangement of the templates for each business entity to be an inspection object. FIG. 5A is a diagram illustrating an example of a data structure of the master data. As illustrated in FIG. 5A, in the master data 140b, business entity identification information, a business entity name, a target item, and frame information are associated with one another.

The business entity identification information is information for identifying a business entity. The business entity name is a name of the business entity. The target item is an item to be an inspection object. The frame information includes pieces of information on the order of arrangement of templates, input items, inspection results, and the like corresponding to the business entity identification information.

FIG. 5B is a diagram illustrating an example of a data structure of the frame information. Herein, as one example, the frame information illustrated in FIG. 5B is frame information corresponding to business entity information of “1001”. As illustrated in FIG. 5B, in the frame information, the order, the template identification information, a check content description, selection information, and an inspection result are associated with one another.

The order is information for specifying the order of arrangement of templates. The template identification information is information for identifying a template. For example, in the example illustrated in FIG. 5B, the order of arrangement of templates corresponding to the business entity information of “1001” indicates that the templates are arranged in order of the templates A, B, C, and C.

The check content description indicates a description registered in the check content description of a corresponding template. The selection information is information for specifying an item to be set in the input field of the template C, a unit to be set in the unit display area of the template C, or the like, for example. It may be possible to provide selection information for specifying an arrangement of buttons specific to each business entity or for specifying text to be displayed, in each of the templates in addition to the template C.

For example, in selection information 1 in the template C, it is specified that an item of the input field 3b is “moisture” and a unit in the unit display area 3c is “%”. In selection information 2 in the template C, it is specified that an item of the input field 3b is “temperature” and a unit in the unit display area 3c is “° C.”. Further, in the selection information 2, it is specified that an item in the input field 3d is “humidity” and a unit in the unit display area 3e is “%”.

The inspection result is information, in which a time at which a button is pressed in each of the templates, a time at which a value is input, and the like are stored for each date. For example, in the information in the first column, there is a record indicating that an “OK” button of the template A is pressed on “2014/3/10” at “8:30”.

The data structure of the master data 140b illustrated in FIG. 5A is one example. For example, the master data 140b may be information that defines the order of arrangement of templates for inspecting a site in the primary industry, the order of arrangement of templates for inspecting a site in the secondary industry, and the order of arrangement of templates for inspecting a site in the tertiary industry.

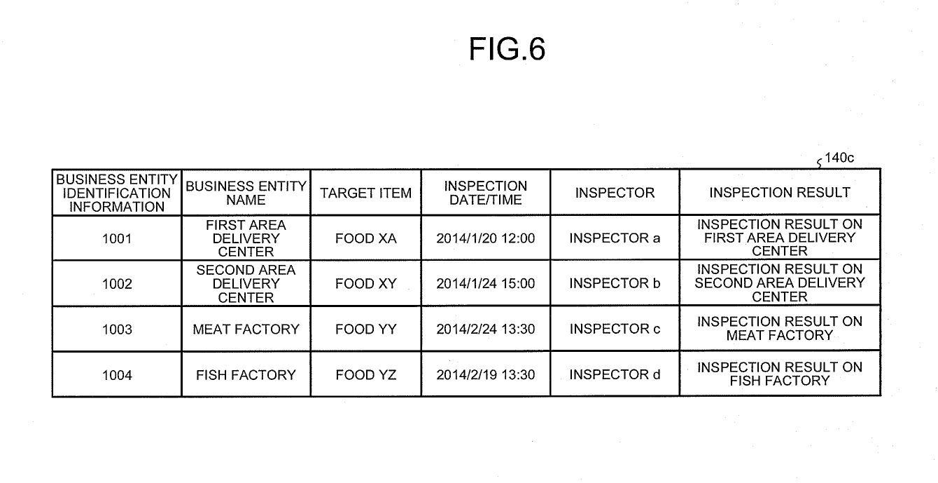

The inspection result table 140c is a table for storing an inspection result. FIG. 6 is a diagram illustrating an example of a data structure of the inspection result table. As illustrated in FIG. 6, the inspection result table 140c stores therein, the business entity identification information, the business entity name, the target item, inspection date and time, an inspector, and an inspection result in an associated manner. The business entity identification information, the entity name, and the target item are the same as those described above with reference to FIG. 5A. The inspection date and time indicates date and time at which an inspection is performed. The inspector is information for identifying an inspector who has performed the inspection. The inspection result is information on a result of the inspection. The inspection result illustrated in FIG. 5B may be included in and registered with the inspection result in the inspection result table 140c.

Referring back to FIG. 2, the control unit 150 includes a receiving unit 150a, a generating unit 150b, and an inspection result managing unit 150c. The control unit 150 corresponds to, for example, an integrated device, such as an application specific integrated circuit (ASIC) or a field programmable gate array (FPGA). Further, the control unit 150 corresponds to, for example, an electronic circuit, such as a central processing unit (CPU) or a micro processing unit (MPU).

The receiving unit 150a is a processing unit that receives a request for a frame screen from the terminal device 10. For example, the request for the frame screen contains the business entity identification information and information on the target item. The receiving unit 150a outputs the business entity identification information and the information on the target item to the generating unit 150b.

The generating unit 150b is a processing unit that generates information on the frame screen and transmits the generated information on the frame screen to the terminal device 10. Hereinafter, an example of a process performed by the generating unit 150b will be described.

The generating unit 150b acquires the business entity identification information and the target item from the receiving unit 150a, compares the business entity identification information, the target item, and the master data 140b with one another, and specifies frame information. The generating unit 150b rearranges templates based on the specified frame information to generate the frame screen. The generating unit 150b acquires information on each of the templates from the template table 140a.

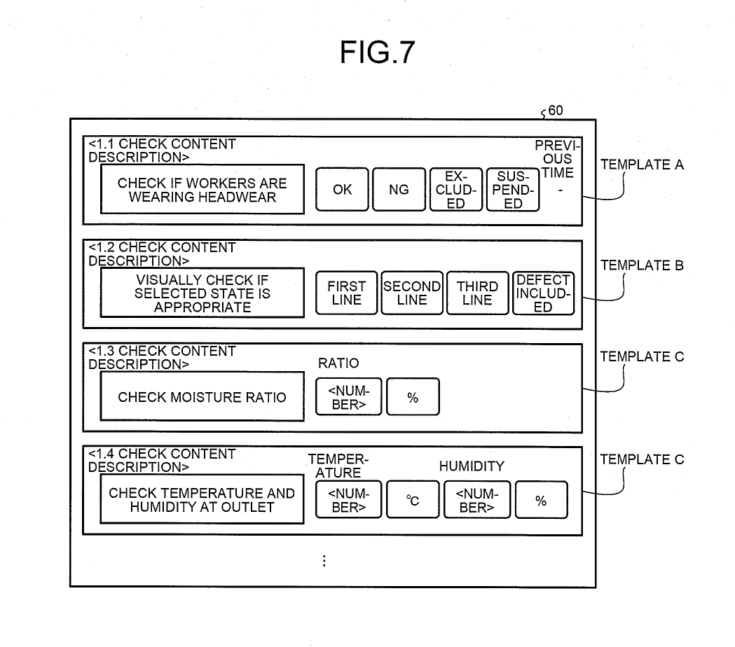

For example, when the business entity identification information is “1001” and the target item is “food XA”, the order of arrangement defined in the frame information is “the templates A, B, C, and C” as illustrated in FIG. 5B. Therefore, the generating unit 150b acquires pieces of data on the templates A, B, and C from the template table 140a. Then, the generating unit 150b arranges the templates A, B, and C in accordance with the frame information to generate information on the frame screen as illustrated in FIG. 7.

Further, the generating unit 150b specifies information on a check content description by referring to the frame information, and sets the specified information on the check content description in the check content description of each of the templates. Furthermore, the generating unit 150b refers to the selection information set in the template, specifies, for example, items and units to be set in the input fields 3b and 3d and the unit display areas 3c and 3e of the template C, and reflects the items and the units in the frame screen. If there is selection information in other templates, the generating unit 150b may appropriately adjust contents of the templates in accordance with the corresponding selection information.

FIG. 7 is a diagram illustrating an example of the frame screen. As illustrated in FIG. 7, in a frame screen 60, the templates are arranged in order of the template A, the template B, the template C, and the template C. The generating unit 150b transmits information on the generated frame screen 60 to the terminal device 10 that has transmitted the request for the frame screen.

The inspection result managing unit 150c is a processing unit that, upon acquiring an inspection result from the terminal device 10, registers information on the acquired inspection result in the inspection result table 140c. Further, the inspection result managing unit 150c, upon receiving a request to refer to the inspection result from the terminal device 10, transmits information on the inspection result table 140c to the terminal device 10.

Furthermore, the inspection result managing unit 150c receives, from the terminal device 10, pieces of information on a type of a button in each of the frame screens, a time at which the button is pressed, and a time at which a value of humidity, temperature, moisture, or the like is input, and registers the received pieces of information in the inspection result in the master data 140b.

Upon detecting a defective state during the inspection, the inspector captures an image of the state by a camera by operating the terminal device 10, and transmits image data of the captured image to the inspection supporting apparatus 100. The inspection result managing unit 150c, upon receiving the image data, may register the received image data in the inspection result table 140c.

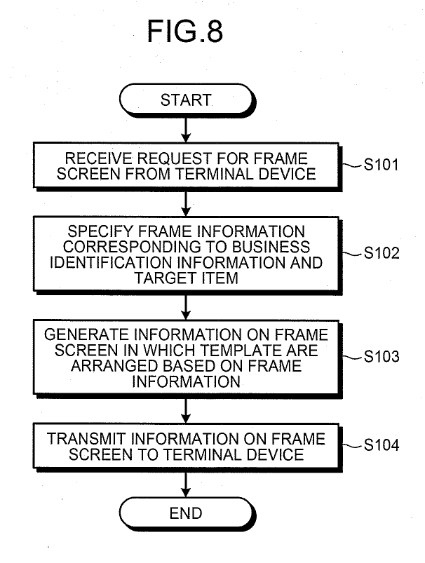

Next, an example of the flow of a process performed by the inspection supporting apparatus 100 according to the embodiment will be described. FIG. 8 is a flowchart illustrating the flow of the process performed by the inspection supporting apparatus according to the embodiment. As illustrated in FIG. 8, the inspection supporting apparatus 100 receives a request for a frame screen from the terminal device 10 (Step S101).

The inspection supporting apparatus 100 specifies frame information corresponding to business entity identification information and a target item (Step S102). The inspection supporting apparatus 100 generates information on a frame screen in which templates are rearranged based on the frame information (Step S103). The inspection supporting apparatus 100 transmits information on the frame screen to the terminal device 10 (Step S104).

Next, an advantageous effect of the inspection supporting apparatus 100 according to the embodiment will be described. The inspection supporting apparatus 100, upon receiving a request for a frame screen, generates a frame, in which different types of templates each having a specific check item stored in the template table 140a are arranged in accordance with an inspection object. Therefore, according to the inspection supporting apparatus 100, it is possible to efficiently support different types of inspections.

The inspection supporting apparatus 100 stores different types of the templates A to E in the template table 140a, for example. Therefore, it is possible to efficiently generate a frame corresponding to different types of inspections.

The inspection supporting apparatus 100 receives a request for a frame screen from the terminal device 10 via the network 50, and transmits information on the frame screen to the terminal device 10 via the network 50. Therefore, the inspector can acquire information on the template screen and perform inspections at any place where a network connection is possible.

Of the processes described in the embodiments, all or part of a process described as being performed automatically may also be performed manually. Alternatively, all or part of a process described as being performed manually may also be performed automatically by known methods. In addition, the processing procedures, control procedures, specific names, and information including various types of data and parameters illustrated in the above-described document and drawings may be arbitrarily changed unless otherwise specified.

Further, all or an arbitrary part of the processing functions implemented by each device may be realized by a CPU and a program analyzed and executed by the CPU, or may be realized by hardware using wired logic.

According to one aspect of the present invention, it is possible to efficiently support different types of inspection.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An inspection supporting apparatus comprising:
a memory that stores therein different types of templates for each check item that is an inspection object for which it is determined whether a predetermined criterion for a site to handle agricultural crops or foods is satisfied, and stores a master in which the types of the templates and an order of arrangement of the templates are defined for each inspection object; and
a processor executes a process comprising:
referring to the memory; and
generating a frame in which the templates are arranged based on the selected inspection object and the master, upon receiving a selection of an inspection object.

2. The inspection supporting apparatus according to claim 1, wherein the different types of the templates include a template for inputting information on whether an object to be checked satisfies a criterion, a template for inputting a value and a preset unit for the object to be checked, and a template for inputting a comment on the object to be checked.

3. The inspection supporting apparatus according to claim 2, wherein the generating generates a frame in which the different types of the templates are mixed based on the selected inspection object and the master.

4. The inspection supporting apparatus according to claim 1, wherein the master stored in the memory is information that defines an order of arrangement of templates for inspecting a site in primary industry, an order of arrangement of templates for inspecting a site in secondary industry, and a order of arrangement of templates for inspecting a site in tertiary industry.

5. The inspection supporting apparatus according to claim 1, further comprising receiving a selection of an inspection object from a terminal device via a network, and transmitting information on the frame to the terminal device via the network.

6. An inspection supporting method executed by a computer, the inspection supporting method comprising:
referring to a storage device that stores therein different types of templates for each check item that is an inspection object for which it is determined whether a predetermined criterion for a site to handle agricultural crops or foods is satisfied, and that stores a master in which the types of the templates and an order of arrangement of the templates are defined for each inspection object;
receiving a selection of an inspection object; and
generating a frame in which the templates are arranged based on the selected inspection object and the master.
